(19) United States
(12) Patent Application Publication
(10) Pub. No.: US 2017/0186431 A1
(43) Pub. Date: Jun. 29, 2017

(54) Speech to Text Prosthetic Hearing Aid

(71) Applicant: Frank Xavier Didik, Brooklyn, NY (US)

(72) Inventor: Frank Xavier Didik, Brooklyn, NY (US)

(21) Appl. No.: 14/982,194

(22) Filed: Dec. 29, 2015

(51) Int. Cl. G10L 15/26; G10L 21/003; G06K 9/00; G10L 21/10

(52) U.S. Cl. CPC G10L 15/26; G10L 21/10; G10L 21/003; G06K 9/00335; G10L 2021/105

(57) ABSTRACT

The invention is prosthetic hearing aid designed to assist and enrich the lives of people who are hearing impaired or have experienced a total loss of hearing by allowing them to hear or understand what is spoken to them. The invention consists of a frame assembly having left and right temples and a front, a lens assembly secured to the fame assembly, a set of microphones attached to the frame assembly, capable of detecting the sound of the spoken word, a television camera system attached to the frame assembly, that is able to track lip movement, a semi transparent viewing screen and a CPU microprocessor and appropriate electronic software coding in order to convert both the audio as well as the lip movement of the spoken word into text and also change the frequency of the spoken word.

### CROSS REFERENCE TO RELATED APPLICATION

This invention claims benefit from the prior provisional patent application No. 62/097,144 (EFS ID 21070033), dated Dec. 29, 2014.

### FIELD OF THE INVENTION

This invention relates to a hearing aid medical device to assist people who have hearing loss or who needs enhanced hearing ability.

### BACKGROUND OF THE INVENTION

Millions of people world wide suffer from partial or complete hearing loss. Further, in environments with loud ambient noise, it can be very difficult to hear what is being said, particularly if the person speaking is at a greater distance, such as in a conference hall, a large dinner gathering or a sports stadium. A man's speech range is from between 75 Hz and 165 Hz. A woman's speech range is from about 100 Hz to 255 Hz, while a child's voice ranges from 225 Hz to 300 Hz. As a person gets older, they often lose the ability to hear and discern voices in the normal speech range and thus that individual may only be able to catch a few syllables. A person who has spoken to a hearing impaired person may have experienced times when they might say something like “grandma, what a beautiful day” and the response from the grandmother might be “I am not hungry”. The reason for this is that the hearing impaired person can only catch a few frequencies of the spoken word, though is trying to understand what is being said to them. Often, however, the hearing impaired person may still have hearing in either a higher or lower frequency range. Until now, the normal method to enhance a hearing impaired persons hearing is to increase the volume of the spoken word. If a person has partial hearing loss, the prior method of amplifying the sound only has a limited effect, since the hearing impaired person may not be able to hear the frequency, regardless of the volume. Further the present method of amplifying sound is useless for a person who has experienced complete hearing loss. This invention solves the problem of understanding what is spoken to both the person with partial or complete hearing loss. One aspect of this invention is to change the frequency of the spoken word to a frequency range that the hearing impaired person may still be able to hear in. The result will be that the spoken word will sound distorted in that the heard voice will sound either too high or too low, however more importantly, the hearing impaired person will be able to clearly understand what is being spoken. In addition to changing the frequency of the spoken word, the invention also converts audio of the spoken word as well as the lip movement of the speaker, into text that is displayed on the semi-transparent eyeglass screen. Since most people can not necessarily read fast, the invention, through the use of the built in CPU processor and appropriate built in software, the spoken word is truncated to make rapid reading easier. Also through the use of the inventions built in CPU processor and software coding, the invention is able to compare lip movement and spoken word and has the capability of displaying and comparing discrepancies between the two sets of data and also has the ability through preprogrammed software, has the ability to determine the most likely correct message.

The hearing impaired person, through the live, real time audio to text function, lip reading to text function, lip reading to audio and frequency changing technology, can effectively read on the built in viewing screen, what is spoken to them and hear what is spoken to them, if they still have hearing in the normal non-voice frequency range. The hearing impaired or the completely deaf person will also be able to enjoy telephone conversations, watch television, movies, the theater or any other venue with the spoken word.

The built in viewing screen is designed so that it is clear to the hearing impaired person, even when watching a distant speaker.

This invention will be a great benefit and enrich the lives of millions of people world wide, particularly those suffering from partial or complete deafness.

### PRIOR ART

Individually, many of the technologies incorporated in the invention have been researched and various scientific papers have been published. This would include pitch shifting technology, lip reading technology, lip tracking and zooming technology, voice to text technology, amplification technology and audio and video recording technology, however the novel approach of incorporating all of these technologies into portable eye glasses so that the deaf, hearing impaired and those attempting to understand speech in a noisy environment, is completely novel.

### SUMMARY OF THE INVENTION

Millions of people world wide suffer from partial or complete hearing loss. Further, in environments with loud ambient noise, it can be very difficult to hear what is being said, particularly if the person speaking is at a greater distance. This invention converts lip movement into text. This invention also converts the spoken word into text. If the hearing impaired person still has some hearing ability in higher or lower frequencies, the frequency shifting aspect of this invention will be able to shift the spoken word to the said higher or lower frequencies that can still be heard. Further, with the lip reading to text capability, the processed text can then be again converted back to audio in the frequency that the hearing impaired person can still hear. If a person is completely deaf, they will still benefit from this invention since they will be able to read the speech to text on the viewing screen, in their field of vision. As a result of this invention, the hearing impaired person or the completely deaf person will be able to communicate with other people, will be able to watch television, movies, theater and any venue with the spoken word and understand what is being said.

The invention can also be coupled or work in conjunction with other technologies, such as built in television, built in GPS, built in cellular telephone, or a built in computer. Further, the invention can be networked at a live or recorded performance, movie so that what is spoken is automatically converted into subtitles.

The primary purpose of this invention is to convey the spoken word into text and to display this text upon the wearers visor screen. The display may look like a small moving marquee or it may appear to be text floating in the wearer's field of view or the text may appear in front of a translucent or semi transparent area within the user's field of view.

The device may also have its own memory storage unit so to be able to store the text. This acts as a buffer for fast spoken words or for reading at a later time. The speed of the text appearing on the users screen can be real time or can be controlled by the user to be slower than real time, depending upon the speed that the user feels comfortable reading at. In the case of stored text, the playback later can be speeded up. The CPU in the invention can also be programmed to truncate the spoken word into a format that is easier and quicker to read and understand.

The invention can also be programmed with the capability to translate from one spoken language into the text of another language.

The invention contains directional microphones to pick up the spoken word. The user faces the direction of the spoken word. To assist the user in aiming the invention towards the spoken word, the invention may have very fine cross hairs etched into the viewing lenses. Besides the audio pickup, the central processing unit (CPU) microprocessor of the invention may be programmed to lip read so that even in a noisy environment, it may be possible to read the lips of what someone is saying and then convert the lip movement into text, which is both recorded as well as displayed on the inventions display unit. The invention may be further enhanced with the incorporation of a micro video camera using facial detection technology, similar to what is used currently in digital cameras and the inventions CPU containing lip reading software. It is also possible for the camera to automatically zoom into the detected speaking lips, so that the invention has a clearer view of the speaker's lips.

The normal spoken word of a man is from between 75 Hz and 165 Hz. A woman's speech range is from about 100 Hz to 255 Hz, while a child's voice ranges from 225 Hz to 300 Hz. The invention thus has the capability of ignoring other higher and lower frequencies, thus performing better in noisy environments. This is important for the hearing impaired who often have difficulty in hearing clearly in noisy environments. A healthy young person is able to hear frequencies from about 20 to 20,000 Hz, though an older adult may only be able to hear from 40 to 12,000 Hz and is most receptive from 70 to 5,000 Hz. One aspect of the invention is to find the frequency range that the hearing impaired person can still hear and then shift the spoke voice or the processed lip reading to text to audio, to that frequency range.

Through the inventions pre programmed software algorithms, the lip read and the audio to text capability can error check and the best conversion of speech to text can be displayed using artificial intelligence and fuzzy logic. Conflicts between the audio conversion and lip reading may also be displayed in different colors, or shades or fonts either side by side or on top of one another.

The invention can also take the place of a conventional hearing aid by amplifying the spoken word and in cases where a persons hearing loss is limited to certain frequencies, the received spoken word can be replayed at the frequencies that the hearing impaired person can still hear. The frequency shifted speech, though may sound distorted, will allow the hearing impaired person to clearly understand what is being said.

### BRIEF DESCRIPTION OF THE DRAWINGS

FIG. 1 illustrates one embodiment of the invention and shows the major components including A face and lip recognition and tracking camera, B audio pickup microphone, C Micro-processor CPU, D. Speaker which may contain an amplifier and may also be driven by pitch changing technology.

FIG. 2 illustrates another angle of the invention again illustrating the major components of the invention including: A face and lip recognition and tracking camera, B audio pickup microphone, C Micro-processor CPU, D. Speaker which may contain an amplifier and may also be driven by pitch changing technology.

FIG. 3 shows how the invention is used with the optional cross hairs E aimed at the speakers mouth, while the directional microphone is aimed at the lips of the speaker and the speech to text software and the lip reading to text software uses the algorithms to determine the most accurate speech to text. The built in display G projects the text within the field of view of the invention wearer.

FIG. 4 illustrates how the lip tracking software is able to assist in the aiming towards the speaker F and thus facilitate the voice to text software and the automatic lip reading (ALR) software in order to display in text G, what is spoken.

### DESCRIPTION OF THE PROFFERED EMBODIMENT

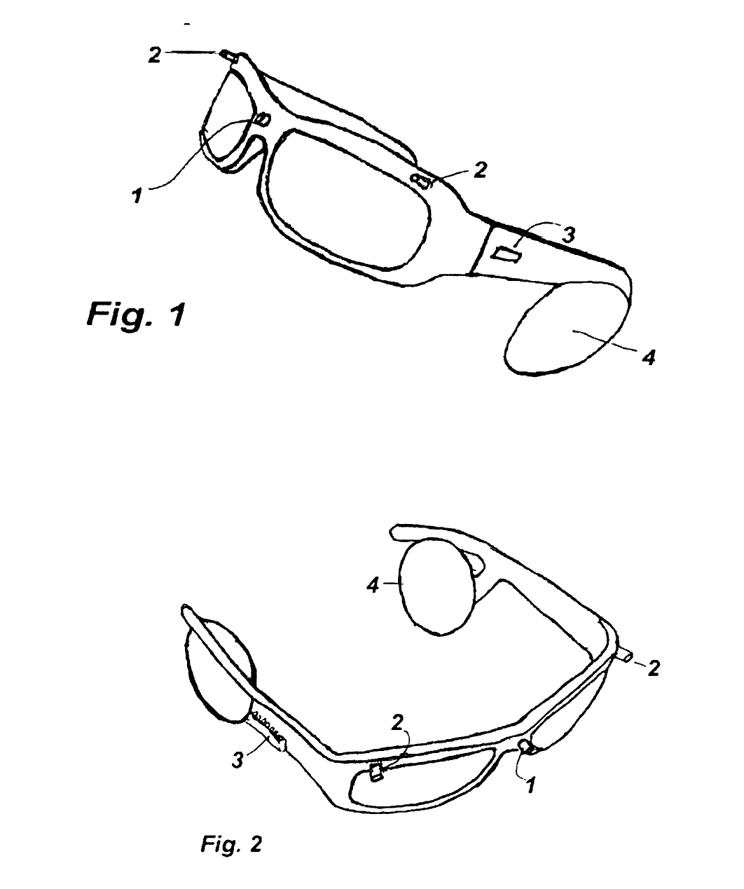

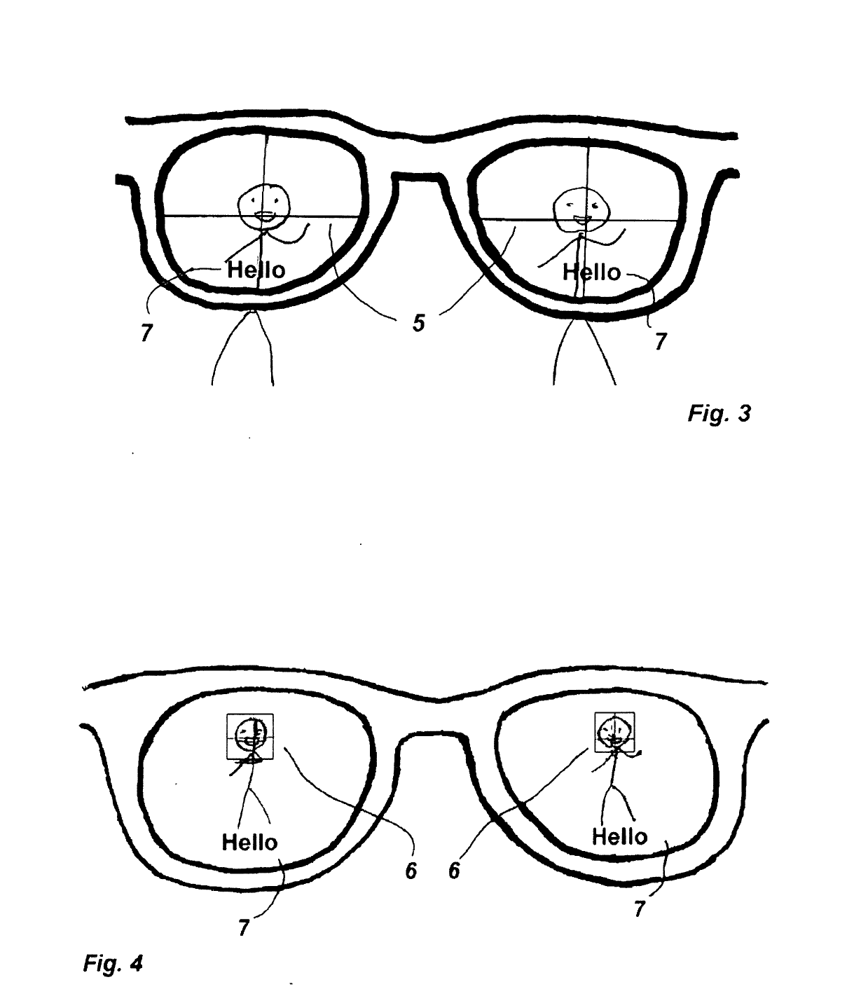

In the preferred embodiment, the invention has the physical appearance of regular eye glasses or sun glasses, and includes a video camera FIG. 1-A, directional microphones FIG. 1-B, a viewing screen FIG. 3, FIG. 4 a microprocessor CPU FIG. 1-C and associated electronics, electronic memory and computer software capable of voice to text translation, lip recognition and tracking software with the capability of zooming the video camera in towards to lips FIG. 4 in order to have a better view of the lips, and lip reading to text translation software. The invention has headphone speakers FIG. 1-D and FIG. 2-D coupled with audible amplification and or pitch shifting technology. The invention has fine cross hairs etched or printed on the glasses FIG. 3-E so that the wearer can manually aim the invention towards the lips of the speaker. In the preferred embodiment, the invention is battery powered, and can also be supplied with a standard AC power adapter. In the preferred embodiment, the invention has input and output connectors so that software can be updated and recorded video, sound and text can be downloaded. One possible example could be a micro USB jack. In the preferred embodiment, the invention also has the ability to have removable and interchangeable memory, one possible example being a micro SD memory card.

In operation, the user wearing the preferred embodiment, faces the speaker and if the speaker is facing the user, tries to keep the speakers lips within the cross hairs FIG. 3-E at the same time, the automatic lip tracking software also zooms into the speakers lips FIG. 4-F and tracks the lips, if either the speaker or the user should move their heads in any off angle. The built in microprocessor CPU and associated electronics and software then converts the audible sound to text and displays this text on the screen FIG. 3-G and FIG. 4-G within the glasses, so that the user can read what the speaker is saying. At the same time, the lip reading software is converting the lip movement to text and this also may be displayed on the screen FIG. 3-G and FIG. 4-G, either next to or above or below the audio text. Further, the built in software and algorithms can compare for any differences between the audio to text versus the lip reading to text and should any differences occur, these differences can be high lighted so that the user can make the determination, what is the most accurate text.

The invention is a great leap forward by having both audio to text as well as lip reading to text. If the invention only had audio to text, its use would be limited to areas where there is very little ambient sound and where the speaker is in very close proximity to the user. By having both lip reading to text as well as audio to text, the distance of the user to the speaker can be significantly father plus the ambient sounds has far less of an effect on the accuracy of the audio to text. The built in audio to text and lip reading to text comparison software and algorithms is able to present accurate text to the user, even in noisy environments or at a distance from the speaker. On the other hand, if the speaker turns away from the user and the speaker's lips are not visible, the audio to text can still potentially provide text of what the speaker is saying. The incorporation of lip reading software also allows the user to potentially understand what someone is saying at a greater distance than what a normal hearing person can hear. One example of this would be sports fan reading what the coach or players are saying, from a distance.

People with partial hearing loss, usually losses hearing in specific hearing ranges, rather than evenly across the general 40 HZ to 12,000 HZ hearing range. Normal speech is in the 75 Hz to 300 Hz range, which also happens to be the common area of partial hearing loss, thus mere amplification of the speakers voice will still not significantly allow the user to understand better. Instead, this invention may also incorporate frequency changing, also known as pitch shifting technology so that the frequencies that the person with partial hearing loss has lost most is shifted to a higher or lower frequency region. The result is that the user with partial hearing loss will now be able to hear all of what is spoken, though since the frequency is different than the original spoken word, the sound may seem distorted or squeaky, but clear and understandable, nevertheless.

It is also possible to incorporate language translating software into the invention so that two people speaking different languages can communicate with one another.

This invention has wide spread uses, but most importantly, it will greatly help the deaf and the elderly, who have diminished hearing, to understand what people are talking about around them. It is estimated that most elderly people experience some hearing loss. This invention will help them to hear or understand significantly better than without the invention and will significantly help those with partial or complete hearing loss to lead far richer and more productive lives.

1. I claim speech to text hearing aid prosthetic device and method that consists of a text screen, microprocessor CPU, video camera, microphone, audio speaker, audio to text software, lip recognition and tracking technology, lip reading to text software, and frequency shift technology.

2. The speech to text hearing aid prosthetic device according to claim 1, wherein said text reading screen is from the group consisting electronic viewing screens.

3. The speech to text hearing aid prosthetic device according to claim 1, wherein said text reading screen may super impose the text within the field of view of the user.

4. The speech to text hearing aid prosthetic device according to claim 1, wherein said video camera can process lip movement of a person speaking.

5. The speech to text hearing aid prosthetic device according to claim 1, contains a microphone in order to pickup and process the spoken word.

6. The speech to text hearing aid prosthetic device according to claim 1, contains a microprocessor CPU and built in software in order to convert the spoken word to text.

7. The speech to text hearing aid prosthetic device according to claim 1, contains software to convert lip movement into text.

8. The speech to text hearing aid prosthetic device according to claim 1, contains software to convert lip movement into audible speech.

9. The speech to text hearing aid prosthetic device according to claim 1, contain software coding technology to shift the frequency of the audible speech.
